(19) United States
(12) Patent Application Publication
(10) Pub. No.: US 2019/0044289 A1
(43) Pub. Date: Feb. 7, 2019

(54) SODIMM CONNECTOR SHIELD TO REDUCE RADIO FREQUENCY INTERFERENCE (RFI)

(71) Applicant: Intel Corporation, Santa Clara, CA (US)

(72) Inventors: XIANG LI, Portland, OR (US); JAEJIN LEE, Hillsboro, OR (US); JUN LIAO, Hillsboro, OR (US); HAO-HAN HSU, Portland, OR (US); GEORGE VERGIS, Portland, OR (US); YUN LING, Portland, OR (US); DONG-HO HAN, Beaverton, OR (US); YUNHUI CHU, Hillsboro, OR (US)

(73) Assignee: Intel Corporation, Santa Clara, CA (US)

(21) Appl. No.: 15/900,450

(22) Filed: Feb. 20, 2018

(51) Int. Cl. H01R 13/6594; H01R 12/73; H01R 43/20

(52) U.S. Cl. CPC H01R 13/6594; H01R 43/205; H01R 12/737

(57) ABSTRACT

A shielded SODIMM system for reducing RF emissions of a SODIMM connector is disclosed herein. SODIMM connector RFI presently interferes with connectivity and is also an obstacle for higher speed memory applications. The shielded SODIMM system includes a SODIMM connector that is at least partially housed by a SODIMM connector shield, to partially and/or substantially reduce or block RF emissions from the SODIMM connector. The SODIMM connector shield is at least partially conductive and is coupled to landing pads on a surface of a motherboard printed circuit board (“PCB”). The landing pads of the motherboard PCB that are coupled to the SODIMM connector shield are coupled to ground, which grounds the SODIMM connector shield. Grounding the SODIMM connector shield that at least partially houses the SODIMM connector reduces RF emissions from the SODIMM connector during information transfer operations.

### TECHNICAL FIELD

The present disclosure relates to systems and methods for reducing radio frequency interference in memory interfaces.

### BACKGROUND

Computer systems, such as personal computers, laptops, etc., typically operate with persistent storage (e.g., hard drives and solid-state drives that do not lose data when power is removed) and non-persistent storage (e.g., random access memory that loses data when power is removed). The non-persistent storage can typically be installed and updated conveniently by sliding memory modules into memory module connectors.

Existing random-access memory (“RAM”) modules include memory dice mounted on a printed circuit board (“PCB”) and are referred to as dual in-line memory modules (“DIMM”). For compact computing systems, such as laptops, RAM modules are configured into small outline dual in-line memory modules (“SODIMM”). In operation, the RAM module PCB is typically inserted into a SODIMM connector that is mounted to a motherboard PCB and that enables easy installation or convenient upgrading of the memory.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIGS. 1A and 1B are diagrams of views depicting an illustrative shielded SODIMM system, according to one embodiment;

FIGS. 2A, 2B, 2C and 2D are diagrams of views depicting an illustrative SODIMM connector shield, according to one embodiment;

FIG. 3 is a diagram of a view depicting an illustrative SODIMM, according to one embodiment;

FIG. 4 is a diagram of view depicting an illustrative motherboard, according to one embodiment;

FIG. 5 is a diagram of a view depicting an illustrative graph that shows some of the potential benefits that may be realized through the implementation of a SODIMM connector shield, according to one embodiment;

FIGS. 6A and 6B are diagrams of graphs that show differences in noise radiation for a SODIMM connector with and without a SODIMM connector shield, according to one embodiment;

FIG. 7 is a high-level flow diagram of an illustrative method for using a SODIMM connector shield to reduce RF radiation from a SODIMM connector, according to one embodiment; and

FIG. 8 is a block diagram of an illustrative processor-based device that includes a SODIMM connector and a SODIMM connector shield, according to one embodiment.

Although the following Detailed Description will proceed with reference being made to illustrative embodiments, many alternatives, modifications and variations thereof will be apparent to those skilled in the art.

### DETAILED DESCRIPTION

A shielded small outline dual in-line memory module (“SODIMM”) system for reducing radio frequency (“RF”) emissions of a SODIMM connector is disclosed herein.

With increases in data rates on RAM channels (e.g., double data rate (“DDR”) RAM), SODIMM connectors have been identified as a major (and possibly a main) source of radio frequency interference (“RFI”) in computing systems employing wireless communications, such as long-term evolution (“LTE”) and WiFi. RFI from SODIMM connectors radiate as noise and cause poor wireless connectivity and decreased wireless data rates.

SODIMM connector RFI presently interferes with connectivity and is also an obstacle for higher speed memory applications. For example, next generation DDR memory technology is targeting beyond 5.0 gigatransfers per second (“GT/s”). Memory buses and radio front end circuitry operate at or above similar fundamental frequencies (e.g., 5.0 GT/s). RFI from SODIMM connectors is therefore stunting advances in original equipment manufacturer (“OEM”) and original design manufacturer (“ODM”) memory technology and products.

The presently disclosed shielded SODIMM system includes a SODIMM connector that is at least partially housed, covered, enclosed, or encapsulated by a SODIMM connector shield, to partially and/or substantially reduce or block RF emissions from the SODIMM connector, according to various embodiments. The SODIMM connector shield is at least partially conductive and is coupled to landing pads on a surface of a motherboard printed circuit board (“PCB”), according to one embodiment. The landing pads of the motherboard PCB that are coupled to the SODIMM connector shield are coupled to ground or another DC voltage reference, which grounds the SODIMM connector shield. Grounding the SODIMM connector shield that at least partially houses, covers, encloses, or encapsulates the SODIMM connector reduces RF emissions (e.g., RFI) from the SODIMM connector during information transfer operations, according to one embodiment. The SODIMM connector shield may reduce RF emissions from the SODIMM connector by up to 99% (e.g., ˜20 dB) at some frequencies, enabling improved wireless connectivity and successful high data transfers (e.g., 5 gigatransfers per second).

As used herein the terms “top” and “bottom” and similar terms designate relative and not absolute directions. Thus, a component described as a “top component” of a device and a component described as a “bottom component” of a device may, when the device is inverted, become the “bottom component” and the “top component,” respectively.

As used herein, the terms “radio frequency” and “RF” refer to all or a portion of the electromagnetic spectrum that exists between frequencies of about 3 kilohertz (kHz) to about 1 Terahertz (THz).

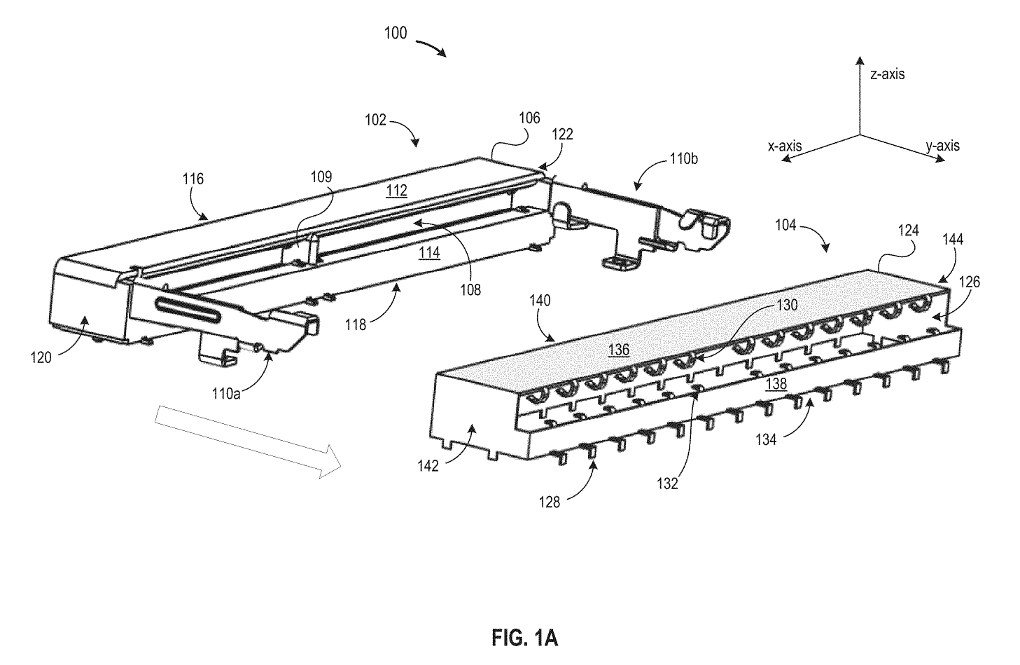

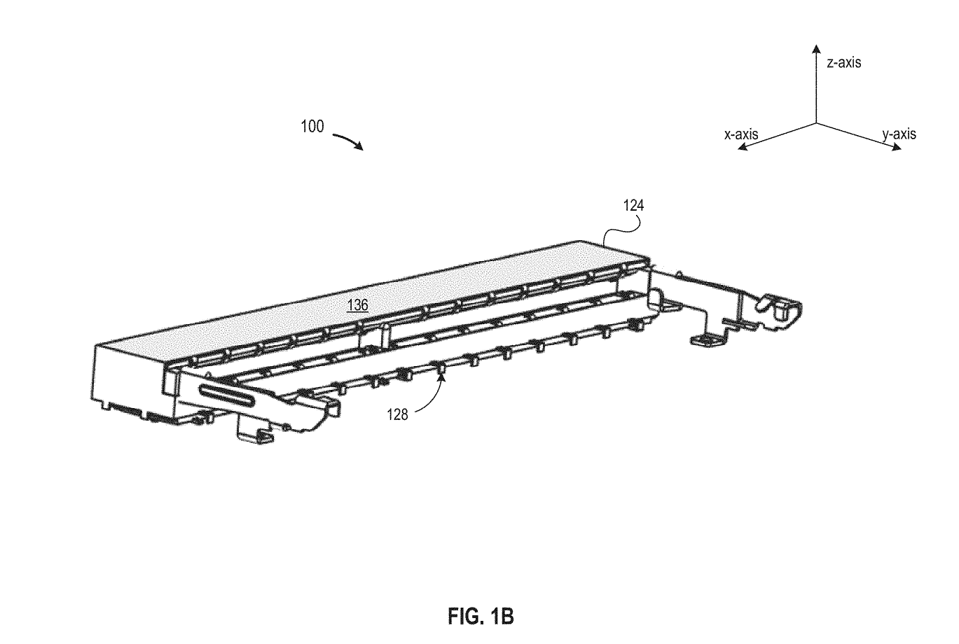

FIGS. 1A and 1B illustrate various views of a shielded small outline dual in-line memory module (“SODIMM”) system 100 that partially or substantially blocks radio frequency (“RF”) interference, radiation or wireless transmissions emitted from a SODIMM connector, according to one embodiment. The shielded SODIMM system 100 can be incorporated into a computing device including, but not limited to, a server, a workstation computer, a desktop computer, a laptop computer, a tablet computer (e.g., iPad®, GalaxyTab® and the like), an ultraportable computer, an ultramobile computer, a netbook computer and/or a subnotebook computer; a mobile telephone including, but not limited to a smart phone, (e.g., iPhone®, Android®-based phone, Blackberry®, Symbian®-based phone, Palm®-based phone, etc.), a feature phone, a router, network attached storage (“NAS”), networking hardware, and/or printers.

FIG. 1A depicts an illustrative exploded perspective view of the shielded SODIMM system 100, according to one embodiment. The shielded SODIMM system 100 includes a SODIMM connector 102 and a SODIMM connector shield 104, according to one embodiment. The SODIMM connector shield 104 is configured to slide over and/or house the SODIMM connector 102, to partially or substantially block RF interference, radiation, or wireless transmissions emitted from the SODIMM connector 102 during information transfer operations within a computing system, according to one embodiment.

The SODIMM connector 102 provides an interface between a motherboard printed circuit board (“PCB”) and memory mounted on a SODIMM PCB, according to one embodiment. The SODIMM connector 102 receives the SODIMM PCB, physically supports the SODIMM PCB, and provides electrical coupling between the SODIMM PCB and the motherboard PCB, according to one embodiment. The SODIMM connector 102 includes a body 106, an aperture 108, and support arms 110 (individually, support arm 110a and support arm 110b), to provide an interface between a SODIMM PCB and a motherboard PCB, according to one embodiment.

The body 106 includes a number of surfaces to facilitate receiving and supporting a SODIMM PCB, according to one embodiment. The body 106 includes a top surface 112, a front surface 114, a rear surface 116, a bottom surface 118, a side surface 120, and a side surface 122, according to one embodiment. The body 106 may be rectangular and may have rounded corners along one or more perimeter edges. The body 106 has an x-axis, a y-axis, and a z-axis. A length for the body 106, the top surface 112, the front surface 114, the rear surface 116, and the bottom surface 118 is defined along the x-axis (e.g., a longitudinal axis), according to one embodiment. A width for the body 106, the top surface 112, the bottom surface 118, the side surface 120, and the side surface 122 is defined along the y-axis (e.g., a lateral axis), according to one embodiment. A height for the body 106, the front surface 114, the rear surface 116, the side surface 120, and the side surface 122, is defined along the z-axis (e.g., a vertical axis), according to one embodiment.

The body 106 defines the aperture 108, according to one embodiment. The aperture 108 may be defined between an edge of the top surface 112 and an edge of the front surface 114. The aperture 108 is configured to receive a memory module, such as a SODIMM PCB, according to one embodiment. Within the aperture 108, the body 106 includes a support member 109 that mates with a notch in a SODIMM PCB to facilitate alignment between connectors within the SODIMM connector 102 and landing pads on the SODIMM PCB, according to one embodiment.

The support arms 110 are configured to hold a SODIMM PCB in place while the SODIMM PCB is coupled to the SODIMM connector 102 through the aperture 108, according to one embodiment. The support arms 110 extend perpendicularly from the front surface 114, according to one embodiment. The support arms 110 extend from the body 106 and parallel to the side surfaces 120, 122, according to one embodiment.

The SODIMM connector shield 104 provides an RF shield for the SODIMM connector 102, by partially and/or substantially blocking or reducing RF interference, radiation, or wireless transmissions emitted from the SODIMM connector 102, according to one embodiment. As used herein, partially blocking or reducing RF interference, radiation, or wireless transmissions emitted from the SODIMM connector 102 includes blocking or reducing RF interference, radiation, or wireless transmissions by at least 49 percent or at least 3 dB, according to one embodiment. As used herein, substantially blocking or reducing RF interference, radiation, or wireless transmissions that emanate from the SODIMM connector 102 includes blocking or reducing RF interference, radiation, or wireless transmissions by at least 90 percent or 10 dB, according to one embodiment. As used herein, substantially blocking or reducing RF interference, radiation, or wireless transmissions that emanate from the SODIMM connector 102 includes blocking or reducing RF interference, radiation, or wireless transmissions by at least 99 percent or 20 dB (+/−2 dB), according to one embodiment.

The SODIMM connector shield 104 functions as an RF shield by at least partially housing the SODIMM connector 102, according to one embodiment. The SODIMM connector shield 104 includes a housing member 124, an aperture 126, a plurality of motherboard PCB connectors 128, a plurality of upper SODIMM connectors 130, a plurality of lower SODIMM connectors 132, and an aperture 134, according to one embodiment. The housing member 124 may be rectangular and may have rounded corners along one or more perimeter edges. The housing member 124 is the body of the SODIMM connector shield 104, according to one embodiment. The housing member 124 includes an x-axis, a y-axis, and a z-axis. A length for the housing member 124, a top surface 136, a front surface 138, a rear surface 140, and the aperture 134 is defined along the x-axis (e.g., a longitudinal axis), according to one embodiment. A width for the housing member 124, the top surface 136, a side surface 142, a side surface 144, and the aperture 134 is defined along the y-axis (e.g., a lateral axis), according to one embodiment. A height for the housing member 124, the front surface 138, the rear surface 140, the side surface 142, and the side surface 144, is defined along the z-axis (e.g., a vertical axis), according to one embodiment.

The housing member 124 and/or the SODIMM connector shield 104 can include or can be manufactured from one or more of a number of materials. For example, the housing member 124 can be made from aluminum, steel, copper, gold, silver, another metal, and/or a combination of one or more metals. The housing member 124 can be made from a combination of metal and non-conductive material, such as a composite. For example, the housing member 124 can be mostly metal an include one or more windows, slots, or other portions that are made of a composite or non-conductive material, according to one embodiment.

The aperture 126 is defined by a perimeter that includes an edge of the top surface 136 and an edge of the front surface 138, according to one embodiment. The aperture 126 is defined by a perimeter that includes an edge of the top surface 136, an edge of the front surface 138, an edge of the side surface 142, and an edge of the side surface 144, according to one embodiment. One edge of the aperture 126 is lined with and/or carries the plurality of upper SODIMM connectors 130, according to one embodiment. One edge of the aperture 126 is lined with and/or carries the plurality of lower SODIMM connectors 132, according to one embodiment.

The plurality of upper SODIMM connectors 130 mechanically and electrically couple a SODIMM PCB to the SODIMM connector shield 104, according to one embodiment. Each of the plurality of upper SODIMM connectors 130 is conductive, according to one embodiment. Each of the plurality of upper SODIMM connectors 130 is arcuate to facilitate providing a spring tension against the SODIMM PCB while the SODIMM PCB is received within the aperture 126, according to one embodiment. Each of the plurality of upper SODIMM connectors 130 is arcuate and includes a distal end that is oriented towards an inner cavity of the housing member 124, according to one embodiment. In one embodiment, the plurality of upper SODIMM connectors 130 are configured to electrically couple the SODIMM connector shield 104 to one or more landing pads disposed on an upper surface (e.g., a first surface) of the SODIMM PCB, to facilitate grounding the SODIMM PCB and the housing member 124, according to one embodiment.

The plurality of lower SODIMM connectors 132 mechanically and electrically couple a SODIMM PCB to the SODIMM connector shield 104, according to one embodiment. Each of the plurality of lower SODIMM connectors 132 is conductive, according to one embodiment. Each of the plurality of lower SODIMM connectors 132 is arcuate to facilitate providing a spring tension against a lower surface of the SODIMM PCB, according to one embodiment. Each of the plurality of lower SODIMM connectors 132 includes a distal end that is oriented toward an inner cavity of the housing member 124, according to one embodiment. The plurality of lower SODIMM connectors 132 are configured to electrically couple the SODIMM connector shield 104 to one or more landing pads disposed on a lower surface (e.g., a second surface) of the SODIMM PCB, according to one embodiment.

The plurality of motherboard PCB connectors 128 are disposed around a perimeter of the housing member 124, and the perimeter of the housing member 124 is a perimeter that is proximate to a surface of the motherboard PCB when the SODIMM connector 102 and the SODIMM connector shield 104 are mounted and/or coupled to a motherboard PCB, according to one embodiment. The plurality of motherboard PCB connectors 128 are disposed around the perimeter of the aperture 134, according to one embodiment. The plurality of motherboard PCB connectors 128 are disposed onto one perimeter edge or onto multiple perimeter edges of the aperture 134, according to one embodiment. The plurality of motherboard PCB connectors 128 are conductive, according to one embodiment. The plurality of motherboard PCB connectors 128 are pins, according to one embodiment. The plurality of motherboard PCB connectors 128 electrically couple the SODIMM connector shield 104 to one or more landing pads disposed on a surface of a motherboard PCB, to facilitate grounding the SODIMM connector shield 104, according to one embodiment.

The aperture 134 is transversely opposed to the top surface 136, according to one embodiment. The aperture 134 enables the support arms 110 to be inserted through the aperture 126, according to one embodiment. The aperture 134 receives the body 106 of the SODIMM connector 102 to enable the body 106 to be inserted into a cavity of the SODIMM connector shield 104, according to one embodiment. The aperture 134 receives the body 106 of the SODIMM connector 102 to enable the housing member 124 to at least partially house, to at least partially cover, or to at least partially enclose the body 106 of the SODIMM connector 102, according to one embodiment.

FIG. 1B depicts an illustrative perspective view of the shielded SODIMM system 100, according to one embodiment. FIG. 1B depicts an illustrative perspective view of the SODIMM connector shield 104 at least partially housing, covering, enclosing, and/or encapsulating the body 106 of the SODIMM connector 102, according to one embodiment.

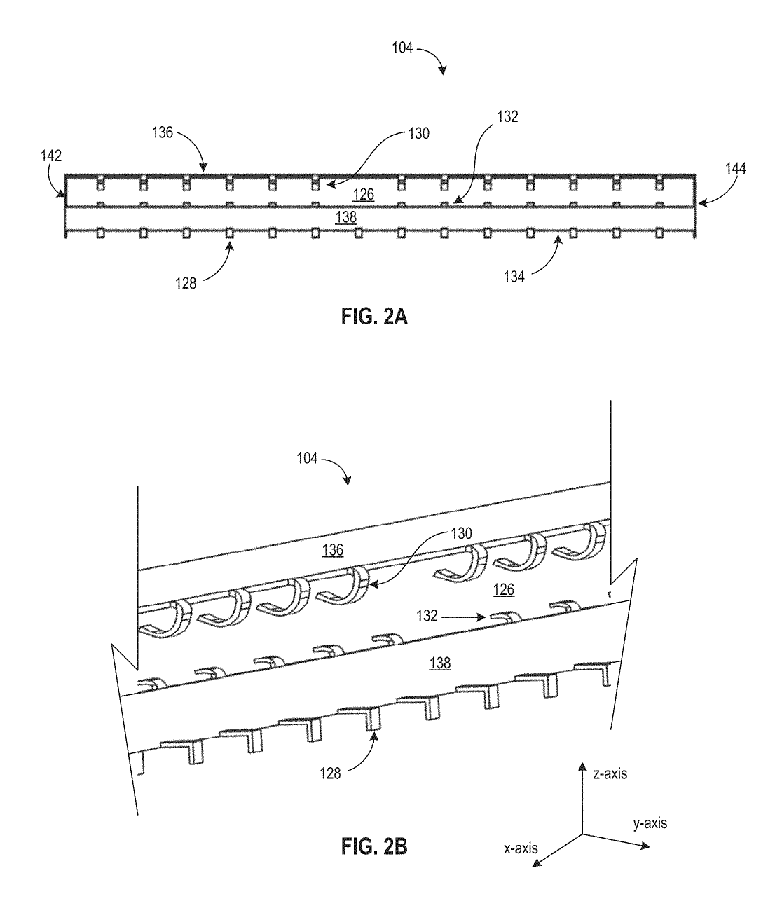

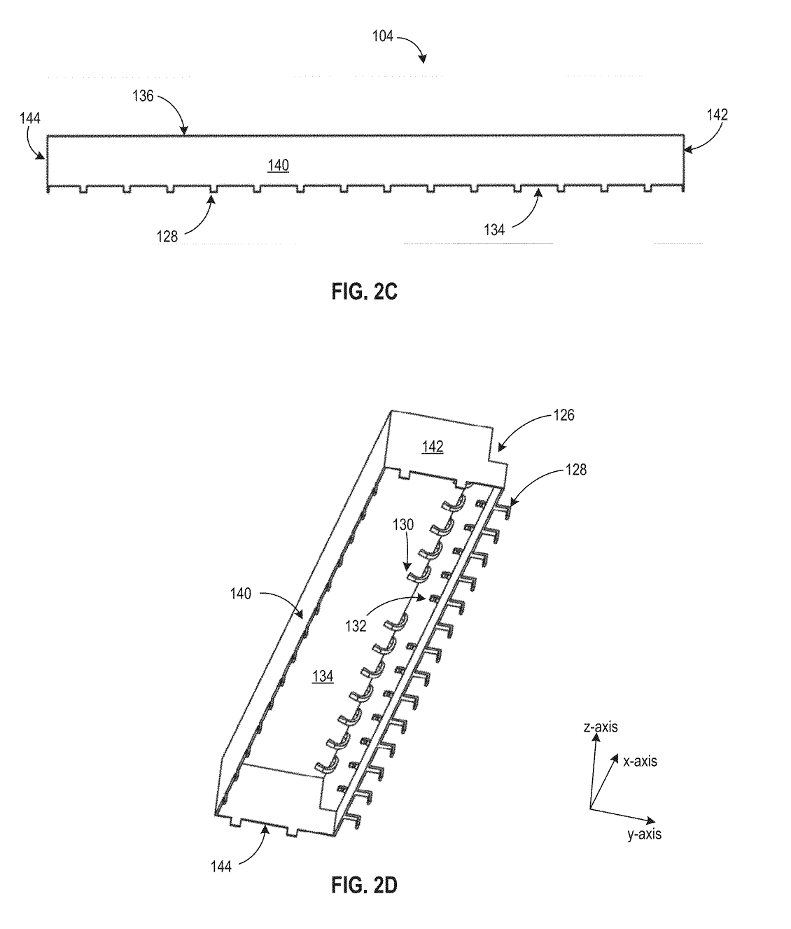

FIGS. 2A, 2B, 2C, and 2D depict various illustrative views of the SODIMM connector shield 104. FIG. 2A depicts an illustrative front plan view of the SODIMM connector shield 104, according to one embodiment. FIG. 2B depicts an illustrative partial perspective view of a front orientation of the SODIMM connector shield 104, according to one embodiment. FIG. 2C depicts an illustrative rear plan view of the SODIMM connector shield 104, according to one embodiment. FIG. 2D depicts an illustrative perspective view of a bottom rear orientation of the SODIMM connector shield 104, according to one embodiment.

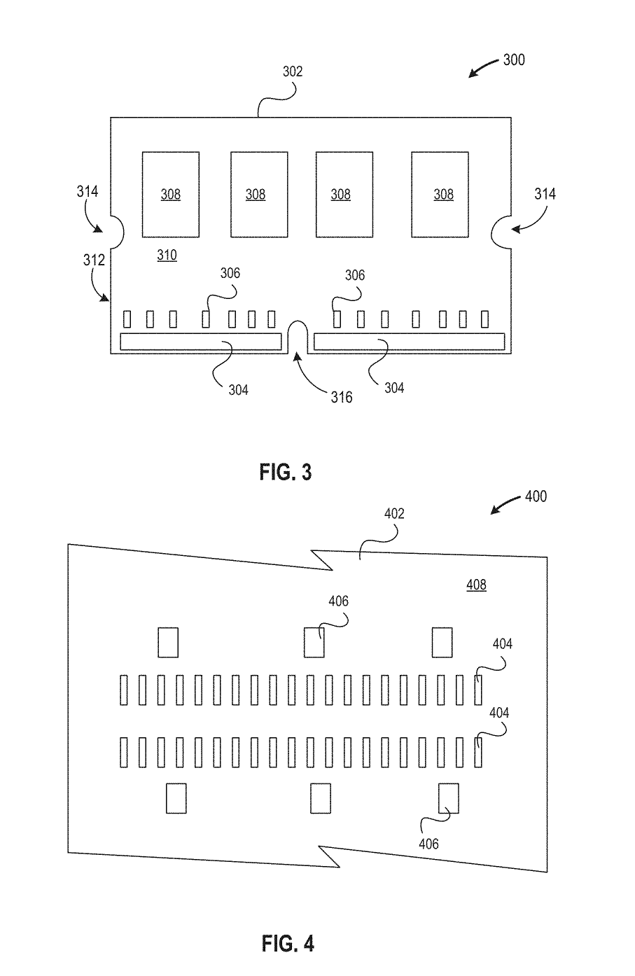

FIG. 3 depicts an illustrative view of a SODIMM 300 that may be received by the SODIMM connector 102 and the SODIMM connector shield 104, according to one embodiment. The SODIMM 300 includes a SODIMM PCB 302, input/output landing pads 304, ground landing pads 306, and memory dice 308, according to one embodiment.

The SODIMM PCB 302 includes a top surface 310 (e.g., a first surface) and a bottom surface 312 (e.g., a second surface), according to one embodiment. The SODIMM PCB 302 includes detents or notches 314 located on one or more sides of the SODIMM PCB 302 to enable the SODIMM connector 102 to provide lateral support to the SODIMM PCB 302, according to one embodiment. The SODIMM PCB 302 includes a notch 316 that aligns the input/output landing pads 304 within the SODIMM connector 102 when the SODIMM PCB 302 is inserted into the SODIMM connector 102, according to one embodiment. The bottom surface 312 may include one or more of the features or components illustrated on the top surface 310 of the SODIMM 300, according to one embodiment.

The input/output landing pads 304 include tens or hundreds of landing pads that facilitate electrical coupling between the memory dice 308 and the SODIMM connector 102, according to one embodiment.

The ground landing pads 306 include a plurality of landing pads that may be disposed on both the top surface 310 and the bottom surface 312 of the SODIMM PCB 302, according to one embodiment. The ground landing pads 306 are configured to interface with one or more of the plurality of upper SODIMM connectors 130 (shown in FIG. 1A) and with one or more of the plurality of lower SODIMM connectors 132 (shown in FIG. 1B), according to one embodiment. The ground landing pads 306 facilitate additional ground plane or reference plane connections that may reduce noise in data signals transmitted on the input/output landing pads 304, according to one embodiment.

The memory dice 308 may be random access memory (“RAM”) or may be non-volatile memory, according to one embodiment. The memory dice 308 may include, but are not limited to, synchronous dynamic RAM (“SDRAM”), double data rate SDRAM (“DDR SDRAM”), and Rambus DRAM (“RDRAM”). Non-volatile memory includes storage media that does not require power to maintain the state of data stored by the storage medium, according to one embodiment. The memory dice 308 may include, but are not limited to, a NAND non-volatile memory (e.g., Single-Level Cell (“SLC”), Multi-Level Cell (“MLC”), Quad-Level Cell (“QLC”), Tri-Level Cell (“TLC”), or some other NAND), NOR memory, solid state memory (e.g., planar or three-dimensional (3D) NAND non-volatile memory or NOR non-volatile memory), memory devices that use chalcogenide phase change material (e.g., chalcogenide glass), byte addressable nonvolatile memory devices, ferroelectric memory, silicon-oxide-nitride-oxide-silicon (“SONOS”) memory, polymer memory (e.g., ferroelectric polymer memory), byte addressable random accessible 3D XPoint™ memory, ferroelectric transistor random access memory (“Fe-TRAM”), magnetoresistive random access memory (“MRAM”), phase change memory (“PCM”, “PRAM”), resistive memory, ferroelectric memory (“F-RAM”, “FeRAM”), spin-transfer torque memory (“STT”), thermal assisted switching memory (“TAS”), millipede memory, floating junction gate memory (“FJG RAM”), magnetic tunnel junction (“MTJ”) memory, electrochemical cells (“ECM”) memory, binary oxide filament cell memory, interfacial switching memory, battery-backed RAM, ovonic memory, nanowire memory, electrically erasable programmable read-only memory (“EEPROM”), etc. In some embodiments, the byte addressable random accessible 3D XPoint™ memory may include a transistor-less stackable cross point architecture in which memory cells sit at the intersection of words lines and bitlines and are individually addressable and in which bit storage is based on a change in bulk resistance, in accordance with various embodiments.

FIG. 4 depicts an illustrative partial top plan view of a motherboard 400, according to one embodiment. The motherboard 400 includes a motherboard PCB 402, input/output landing pads 404, and ground landing pads 406, according to one embodiment. The motherboard PCB 402 includes a surface 408 that is configured to carry the shielded SODIMM system 100, according to one embodiment. The input/output landing pads 404 receive and are coupleable to connectors or pins that extend from the bottom of the SODIMM connector 102 and that are electrically coupled to the input/output landing pads 304 of the SODIMM PCB 302, to facilitate data transfer between the motherboard 400 and the memory dice 308 of the SODIMM 300, according to one embodiment. The ground landing pads 406 receive and are coupleable to the plurality of motherboard PCB connectors 128 (shown in FIG. 1A), to provide ground or reference connections between the motherboard 400 and the SODIMM connector shield 104, according to one embodiment.

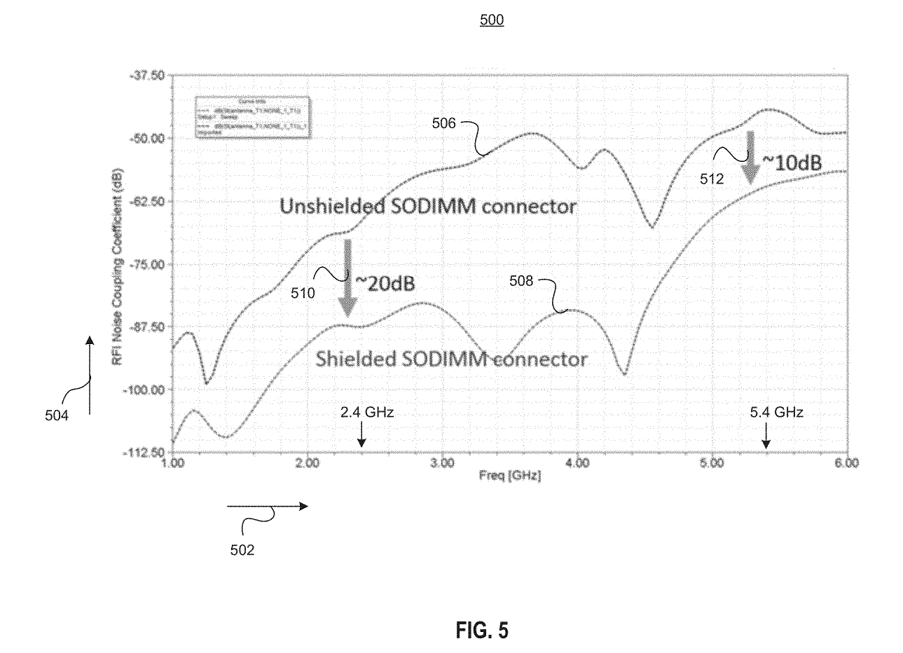

FIG. 5 depicts an illustrative graph 500 that shows some of the potential benefits that may be realized through the implementation of the SODIMM connector shield 104. The graph 500 includes an x-axis 502 and a y-axis 504. The x-axis 502 represents frequency in Gigahertz (“GHz”), and the y-axis 504 represents RFI noise coupling coefficient in decibels (“dB”). The graph 500 includes a plot 506 of an unshielded SODIMM connector and includes a plot 508 of a shielded SODIMM connector that is shielded with the SODIMM connector shield 104 (shown in FIG. 1A), according to one embodiment. At approximately 2.4 GHz (+/−0.1 GHz), an improvement 510 may include approximately a 20 dB decrease in RFI noise coupling coefficient between the plot 506 and the plot 508. At approximately 5.4 GHz (+/−0.2 GHz), an improvement 512 may include approximately a 10 dB decrease in RFI noise coupling coefficient between the plot 506 and the plot 508.

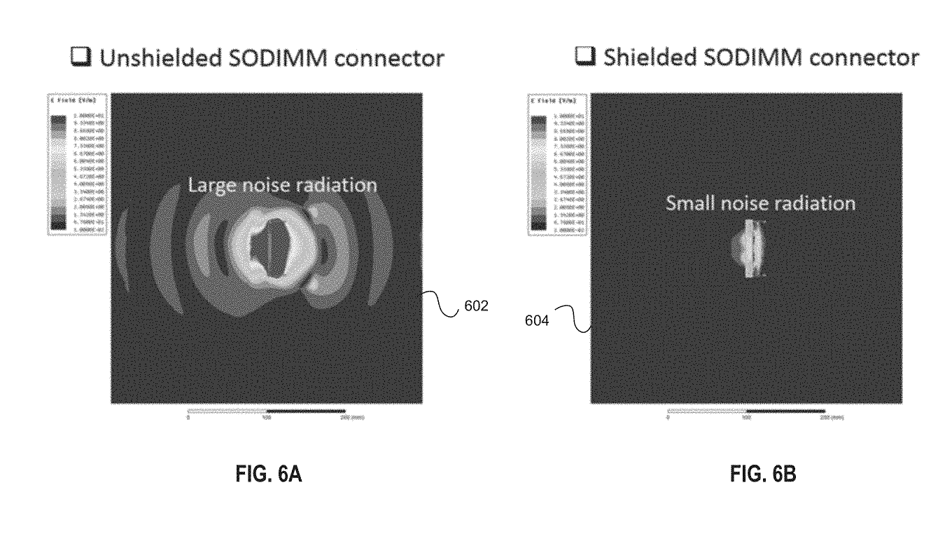

FIGS. 6A and 6B depict illustrative graphs that show differences in noise radiation for a SODIMM connector with and without the SODIMM connector shield 104 (shown in FIG. 1A). FIG. 6A depicts an illustrative graph 602 of noise radiation of an unshielded SODIMM connector 102 (shown in FIG. 1A) and an illustrative graph 604 of reduced noise radiation of the SODIMM connector 102 housed by the SODIMM connector shield 104 (shown in FIG. 1A).

Various alternative configurations of the shielded SODIMM system 100 may be used, according to various embodiments. For example, the SODIMM connector 102 can be a dual in-line memory module (“DIMM”) connector, a single in-line memory module (“SIMM”) connector, or a Rambus in-line memory module (“RIMM”) connector, according to various embodiments. Although the SODIMM connector shield is configured for a SODIMM connector 102 that carries a SODIMM PCB parallel to a surface of a motherboard PCB, the SODIMM connector shield 104 may be configured to house a SODIMM, DIMM, RIMM, or SIMM connector that is oriented to carry a SODIMM, DIMM, RIMM, or SIMM PCB orthogonally to a surface of a motherboard PCB or at an angle (e.g., 60 degrees) that is between parallel and orthogonal to a surface of a motherboard PCB, according to various embodiments

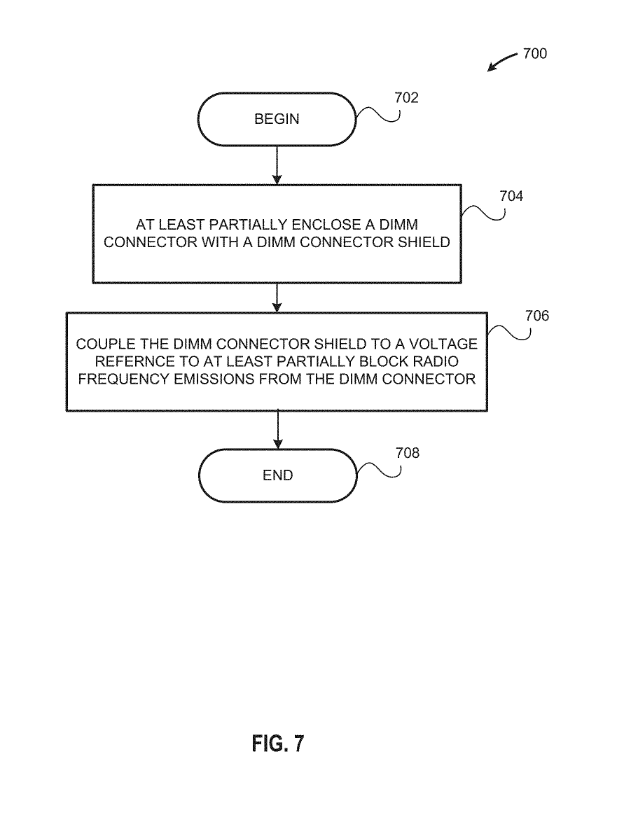

FIG. 7 is a high-level logic flow diagram of an illustrative method 700 for using a SODIMM connector shield to reduce RF radiation from a SODIMM connector, in accordance with at least one embodiment described herein. At operation 702, the method begins.

At operation 704, the method 700 includes at least partially enclosing a DIMM connector with a DIMM connector shield, according to one embodiment.

At operation 706, the method 700 includes coupling the DIMM connector shield to a reference voltage to at least partially block radio frequency emissions from the DIMM connector, according to one embodiment.

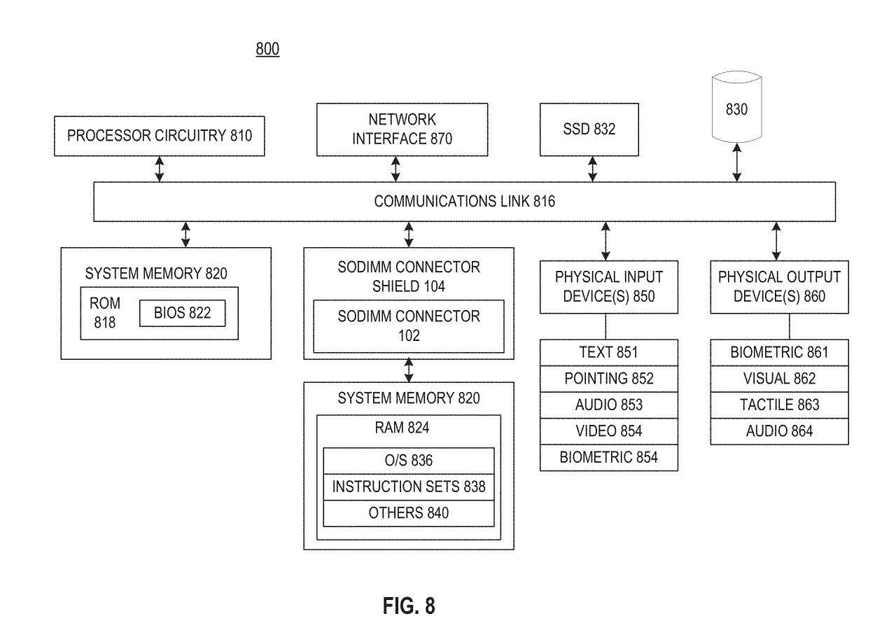

At operation 708, the method 700 ends. FIG. 8 is a block diagram of an illustrative processor-based device 800 equipped with the SODIMM connector 102 and the SODIMM connector shield 104, such as is described above with regard to FIGS. 1A, 1B, 2A, 2B, 2C and 2D, in accordance with at least one embodiment described herein. The following discussion provides a brief, general description of the components forming the illustrative processor-based device 800 such as a smartphone, wearable computing device, portable computing device, or similar device and having the features depicted in any of FIGS. 1A through 4.

The processor-based device 800 includes processor circuitry 810 capable of executing machine-readable instruction sets, reading data from a data storage device 830 and writing data to the data storage device 830. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like.

The processor circuitry 810 may include any number of hardwired or configurable circuits, some or all of which may include programmable and/or configurable combinations of electronic components, semiconductor devices, and/or logic elements that are disposed partially or wholly in a PC, server, or other computing system capable of executing machine-readable instructions. The processor-based device 800 includes the processor circuitry 810 and bus or similar communications link 816 that communicably couples and facilitates the exchange of information and/or data between various system components including a system memory 820, one or more rotating data storage devices 830, and/or one or more solid state storage devices (“SSD”) 832. The communications link 816 can represent a motherboard. The processor-based device 800 may be referred to in the singular herein, but this is not intended to limit the embodiments to a single device and/or system, since in certain embodiments, there will be more than one processor-based device 800 that incorporates, includes, or contains any number of communicably coupled, collocated, or remote networked circuits or devices.

The processor circuitry 810 may include any number, type, or combination of devices. At times, the processor circuitry 810 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 8 are of conventional design. Consequently, such blocks need not be described in further detail herein, as they will be understood by those skilled in the relevant art. The communications link 816 that interconnects at least some of the components of the processor-based device 800 may employ any known serial or parallel bus structures or architectures. The communications link 816 can include hardware such as printed circuit boards that are configured with one or more implementations of the shielded SODIMM system 100 (shown in FIGS. 1A and 1B), as disclosed herein.

The system memory 820 may include read-only memory (“ROM”) 818 and random-access memory (“RAM”) 824. A portion of the ROM 818 may be used to store or otherwise retain a basic input/output system (“BIOS”) 822. The BIOS 822 provides basic functionality to the processor-based device 800, for example by causing the processor circuitry 810 to load one or more machine-readable instruction sets. In embodiments, at least some of the one or more machine-readable instruction sets cause at least a portion of the processor circuitry 810 to provide, create, produce, transition, and/or function as a dedicated, specific, and particular machine, for example a word processing machine, a digital image acquisition machine, a media playing machine, a communications device, and similar. The RAM 824 may be a SIMM, RIMM, SODIMM, or DIMM memory module that includes one or more printed circuit boards. The RAM 824 may be coupled to the communications link 816 through the SODIMM connector 102 that is at least partially housed by the SODIMM connector shield 104 to partially or substantially block or reduce RF emissions from the SODIMM connector 102.

The processor-based device 800 may include one or more communicably coupled, non-transitory, data storage devices, such as one or more hard disk drives 830 and/or one or more solid-state storage devices 832. The one or more data storage devices 830 may include any current or future developed storage appliances, networks, and/or devices. Non-limiting examples of such data storage devices 830 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 830 may include one or more removable storage devices, such as one or more non-volatile drives, non-volatile memories, non-volatile storage units, or similar appliances or devices capable of communicable coupling to and decoupling from the processor-based device 800.

The one or more data storage devices 830 and/or the one or more solid-state storage devices 832 may include interfaces or controllers (not shown) communicatively coupling the respective storage device or system to the communications link 816. The one or more data storage devices 830 may store, retain, or otherwise contain machine-readable instruction sets, data structures, program modules, data stores, databases, logical structures, and/or other data useful to the processor circuitry 810 and/or one or more applications executed on or by the processor circuitry 810. In some instances, one or more data storage devices 830 may be communicably coupled to the processor circuitry 810, for example via communications link 816 or via one or more wired communications interfaces (e.g., Universal Serial Bus or USB); one or more wireless communications interfaces (e.g., Bluetooth®, Near Field Communication or NFC); one or more wired network interfaces (e.g., IEEE 802.3 or Ethernet); and/or one or more wireless network interfaces (e.g., IEEE 802.11 or WiFi®).

Machine-readable instruction sets 838 and other programs, applications, logic sets, and/or modules 840 may be stored in whole or in part in the system memory 820. Such instruction sets 838 may be transferred, in whole or in part, from the one or more data storage devices 830 and/or the solid-state storage device 832. The machine-readable instruction sets 838 may be loaded, stored, or otherwise retained in system memory 820, in whole or in part, during execution by the processor circuitry 810. The machine-readable instruction sets 838 may include machine-readable and/or processor-readable code, instructions, or similar logic capable of providing the speech coaching functions and capabilities described herein.

A system user may provide, enter, or otherwise supply commands (e.g., selections, acknowledgements, confirmations, and similar) as well as information and/or data (e.g., subject identification information, color parameters) to the processor-based device 800 using one or more communicably coupled input devices 850. The one or more communicably coupled input devices 850 may be disposed local to or remote from the processor-based device 800. The input devices 850 may include one or more: text entry devices 851 (e.g., keyboard); pointing devices 852 (e.g., mouse, trackball, touchscreen); audio input devices 853; video input devices 854; and/or biometric input devices 855 (e.g., fingerprint scanner, facial recognition, iris print scanner, voice recognition circuitry). In embodiments, at least some of the one or more input devices 850 may include a wired or wireless interface that communicably couples the input device 850 to the processor-based device 800.

The system user may receive output from the processor-based device 800 via one or more output devices 860. In at least some implementations, the one or more output devices 860 may include, but are not limited to, one or more: biometric output devices 861; visual output or display devices 862; tactile output devices 863; audio output devices 864, or combinations thereof. In embodiments, at least some of the one or more output devices 860 may include a wired or a wireless communicable coupling to the processor-based device 802.

For convenience, a network interface 870, the processor circuitry 810, the system memory 820, the one or more input devices 850 and the one or more output devices 860 are illustrated as communicatively coupled to each other via the communications link 816, thereby providing connectivity between the above-described components. In alternative embodiments, the above-described components may be communicatively coupled in a different manner than illustrated in FIG. 8. For example, one or more of the above-described components may be directly coupled to other components, or may be coupled to each other, via one or more intermediary components (not shown). In some embodiments, all or a portion of the communications link 816 may be omitted and the components are coupled directly to each other using suitable wired or wireless connections.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment”, “an embodiment”, or “an implementation” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in any embodiment herein, the term “logic” may refer to an application, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, within a memory controller that executes code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the memory controller circuitry or other systems may be combined in a system-on-a-chip (“SoC”) architecture.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (“CD-ROMs”), compact disk rewritables (“CD-RWs”), and magneto-optical disks, semiconductor devices such as read-only memories (“ROMs”), random access memories (“RAMs”) such as dynamic and static RAMs, erasable programmable read-only memories (“EPROMs”), electrically erasable programmable read-only memories (“EEPROMs”), non-volatile memories, magnetic or optical cards, or any type of storage devices suitable for storing electronic instructions.

In some embodiments, a hardware description language (“HDL”) may be used to specify circuit and/or logic implementation(s) for the various logic and/or circuitry described herein. For example, in one embodiment the hardware description language may comply or be compatible with a very high speed integrated circuits (“VHSIC”) hardware description language (“VHDL”) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (“HDL”) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800TM-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a memory controller, a method, and a system related to improving memory array read rates, as discussed below.

### Example 1

According to this example, there is provided a radio frequency interference (“RFI”) shield for a dual in-line memory module (“DIMM”) connector. The RFI shield includes a housing member to at least partially house a DIMM connector, wherein the housing member is at least partially conductive, wherein the housing member defines an aperture to at least partially receive a DIMM printed circuit board (“PCB”). The RFI shield includes at least one connector to couple the housing member to a surface.

### Example 2

This example includes the elements of example 1, wherein the housing member is rectangular.

### Example 3

This example includes the elements of example 1, wherein the aperture is defined to at least partially receive the DIMM PCB in an orientation that is parallel to the surface.

### Example 4

This example includes the elements of example 1, wherein the aperture is defined to at least partially receive the DIMM PCB in an orientation that is orthogonal to the surface.

### Example 5

This example includes the elements of example 1, wherein the aperture is a first aperture, wherein the housing member defines a second aperture to at least partially receive the DIMM connector.

### Example 6

This example includes the elements of example 1, wherein the surface is a motherboard PCB.

### Example 7

This example includes the elements of example 1, wherein the at least one connector includes a plurality of connectors disposed around a perimeter of the housing member that is proximate to the surface when the housing member is coupled to the surface.

### Example 8

This example includes the elements of example 1, wherein the at least one connector is a pin to electrically couple to a landing pad on the surface.

### Example 9

This example includes the elements of example 1, wherein the at least one connector is at least one first connector, wherein the RFI shield further includes at least one second connector disposed within the aperture to couple the housing member to the DIMM PCB.

### Example 10

This example includes the elements of example 9, wherein the at least one second connector includes a plurality of pins disposed on the housing member within the aperture, wherein at least some of the plurality of pins are to provide spring tension against the DIMM PCB while the DIMM PCB is received within the aperture.

### Example 11

This example includes the elements of example 1, wherein the housing member is to at least partially shield radio frequency (“RF”) radiation sourced from the DIMM connector.

### Example 12

This example includes the elements of example 1, wherein the DIMM PCB is a small outline DIMM (“SODIMM”) PCB and the DIMM connector is a SODIMM connector.

### Example 13

This example includes the elements of example 1, wherein the housing member is metal.

### Example 14

According to this example, there is provided a system. The system includes a dual in-line memory module (“DIMM”) connector for mounting to a motherboard printed circuit board (“PCB”); and a radio frequency interference (“RFI”) shield for the DIMM connector. The RFI shield includes a housing member to at least partially house the DIMM connector, wherein the housing member is at least partially conductive, wherein the housing member defines an aperture to at least partially receive a DIMM PCB of a DIMM. The RFI shield includes at least one connector to couple the housing member to a surface of the motherboard PCB.

### Example 15

This example includes the elements of example 14, wherein the aperture is defined to at least partially receive the DIMM PCB in an orientation that is parallel to the surface.

### Example 16

This example includes the elements of example 14, wherein the aperture is a first aperture, wherein the housing member defines a second aperture to at least partially receive the DIMM connector.

### Example 17

This example includes the elements of example 14, wherein the at least one connector includes a plurality of connectors disposed around a perimeter of the housing member that is proximate to the surface of the motherboard PCB.

### Example 18

This example includes the elements of example 14, wherein the at least one connector is a pin to electrically couple to a landing pad on the surface

### Example 19

This example includes the elements of example 14, wherein the at least one connector is at least one first connector, wherein the RFI shield further includes at least one second connector disposed within the aperture to couple the housing member to the DIMM PCB, wherein the at least one second connector includes a plurality of pins disposed on the housing member within the aperture, wherein at least some of the plurality of pins are to provide spring tension against the DIMM PCB while the DIMM PCB is received within the aperture.

### Example 20

This example includes the elements of example 14, wherein the DIMM PCB is a small outline DIMM (“SODIMM”) PCB and the DIMM connector is a SODIMM connector.

### Example 21

According to this example, there is provided a method. The method includes at least partially enclosing a dual in-line memory module (“DIMM”) connector with a DIMM connector shield; and mounting the DIMM connector to a surface of a motherboard printed circuit board (“PCB”) to couple the DIMM connector shield to a voltage reference to at least partially block radio frequency (“RF”) emissions from the DIMM connector.

### Example 22

This example includes the elements of example 21, wherein the DIMM connector is a small outline dual in-line memory module connector (“SODIMM”) and the DIMM connector shield is a SODIMM connector shield.

### Example 23

This example includes the elements of example 21, wherein the voltage reference is a ground reference.

### Example 24

This example includes the elements of example 21, wherein coupling the DIMM connector to a voltage reference includes coupling at least one connector of the DIMM connector shield to landing pads on the surface of the motherboard PCB.

### Example 25

According to this example, there is provided a radio frequency interference (“RFI”) shield. The RFI shield includes means for at least partially housing a dual in-line memory module (“DIMM”) connector, wherein the means for at least partially housing the DIMM connector is at least partially conductive, wherein the means for at least partially housing the DIMM connector defines an aperture to at least partially receive a DIMM printed circuit board (“PCB”) of a DIMM. The RFI shield includes coupling means for coupling the means for at least partially housing the DIMM connector to a surface of the motherboard PCB.

### Example 26

According to this example, there is provided a device comprising means to perform the method of any one of examples 21 to 24.

### Example 27

According to this example, there is provided a computer readable storage device having stored thereon instructions that when executed by one or more processors result in operations including the method according to any one of examples 21 to 24.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A radio frequency interference (“RFI”) shield for a dual in-line memory module (“DIMM”) connector, comprising:
a housing member to at least partially house a DIMM connector,
wherein the housing member is at least partially conductive,
wherein the housing member defines an aperture to at least partially receive a DIMM printed circuit board (“PCB”); and
at least one connector to couple the housing member to a surface.

2. The RFI shield of claim 1, wherein the housing member is rectangular.

3. The RFI shield of claim 1, wherein the aperture is defined to at least partially receive the DIMM PCB in an orientation that is parallel to the surface.

4. The RFI shield of claim 1, wherein the aperture is defined to at least partially receive the DIMM PCB in an orientation that is orthogonal to the surface.

5. The RFI shield of claim 1, wherein the aperture is a first aperture, wherein the housing member defines a second aperture to at least partially receive the DIMM connector.

6. The RFI shield of claim 1, wherein the surface is a motherboard PCB.

7. The RFI shield of claim 1, wherein the at least one connector includes a plurality of connectors disposed around a perimeter of the housing member that is proximate to the surface when the housing member is coupled to the surface.

8. The RFI shield of claim 1, wherein the at least one connector is a pin to electrically couple to a landing pad on the surface.

9. The RFI shield of claim 1, wherein the at least one connector is at least one first connector, wherein the RFI shield further includes:
at least one second connector disposed within the aperture to couple the housing member to the DIMM PCB.

10. The RFI shield of claim 9, wherein the at least one second connector includes a plurality of pins disposed on the housing member within the aperture, wherein at least some of the plurality of pins are to provide spring tension against the DIMM PCB while the DIMM PCB is received within the aperture.

11. The RFI shield of claim 1, wherein the housing member is to at least partially shield radio frequency (“RF”) radiation sourced from the DIMM connector.

12. The RFI shield of claim 1, wherein the DIMM PCB is a small outline DIMM (“SODIMM”) PCB and the DIMM connector is a SODIMM connector.

13. The RFI shield of claim 1, wherein the housing member is metal.

14. A system, comprising:
a dual in-line memory module (“DIMM”) connector for mounting to a motherboard printed circuit board (“PCB”); and
a radio frequency interference (“RFI”) shield for the DIMM connector, including:
a housing member to at least partially house the DIMM connector,
wherein the housing member is at least partially conductive,
wherein the housing member defines an aperture to at least partially receive a DIMM PCB of a DIMM; and
at least one connector to couple the housing member to a surface of the motherboard PCB.

15. The system of claim 14, wherein the aperture is defined to at least partially receive the DIMM PCB in an orientation that is parallel to the surface.

16. The system of claim 14, wherein the aperture is a first aperture, wherein the housing member defines a second aperture to at least partially receive the DIMM connector.

17. The system of claim 14, wherein the at least one connector includes a plurality of connectors disposed around a perimeter of the housing member that is proximate to the surface of the motherboard PCB.

18. The system of claim 14, wherein the at least one connector is a pin to electrically couple to a landing pad on the surface.

19. The system of claim 14, wherein the at least one connector is at least one first connector, wherein the RFI shield further includes:
at least one second connector disposed within the aperture to couple the housing member to the DIMM PCB, wherein the at least one second connector includes a plurality of pins disposed on the housing member within the aperture, wherein at least some of the plurality of pins are to provide spring tension against the DIMM PCB while the DIMM PCB is received within the aperture.

20. The system of claim 14, wherein the DIMM PCB is a small outline DIMM (“SODIMM”) PCB and the DIMM connector is a SODIMM connector.

21. A method, comprising:
at least partially enclosing a dual in-line memory module (“DIMM”) connector with a DIMM connector shield; and
mounting the DIMM connector to a surface of a motherboard printed circuit board (“PCB”) to couple the DIMM connector shield to a voltage reference to at least partially block radio frequency (“RF”) emissions from the DIMM connector.

22. The method of claim 21, wherein the DIMM connector is a small outline dual in-line memory module connector (“SODIMM”) and the DIMM connector shield is a SODIMM connector shield.

23. The method of claim 21, wherein the voltage reference is a ground reference.

24. The method of claim 21, wherein coupling the DIMM connector to a voltage reference includes coupling at least one connector of the DIMM connector shield to landing pads on the surface of the motherboard PCB.
